(19) United States
(12) Patent Application Publication
(10) Pub. No.: US 2013/0238407 A1
(43) Pub. Date: Sep. 12, 2013

(54) VISUAL CHECK-IN FEATURE USING A SOFTWARE SERVICE

(71) Applicant: Kevin John Bradshaw, Old Saybrook, CT (US)

(72) Inventor: Kevin John Bradshaw, Old Saybrook, CT (US)

(73) Assignee: Beer Dog LLC, Old Saybrook, CT (US)

(21) Appl. No.: 13/417,903

(22) Filed: Mar. 12, 2012

(51) Int. Cl. G06Q 30/02

(52) U.S. Cl. 705/14.1

(57) ABSTRACT

A system and method of accumulating points redeemable for goods or services using a visual check-in feature. An electronic file indicative of a digital photograph of a physical object taken by a user is received. The electronic file includes an image of the physical object and associated location information of where the digital photograph was taken. An image recognition engine identifies an indicium associated with the physical object. The user is granted access to a software service based on the digital photograph and the location information, both of which are required to access the software service. A software service determines whether the identified indicium matches one of predetermined indicia stored in a database. If so, points are awarded to the user based on the matching indicium and location information, and the awarded points are added to a point meter. The accumulated points are redeemable for goods or services.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE PRESENT DISCLOSURE

The present disclosure relates to a visual check-in feature that uses a software service to accumulate rewards by participants that can be redeemed for goods or services.

### SUMMARY

Aspects of the present disclosure relate to systems and methods of accumulating points redeemable for goods or services using a visual check-in feature. A “check-in” is used by software services, such as an online social networking service, to allow the user access to the social network. By “visual” it is meant that the check-in procedure according to aspects of the present disclosure require that the user take a photograph of a physical object and send it to the software service to gain access to the software service. The electronic file corresponding to the photograph includes metadata indicative of geographic coordinates where the photograph was taken. Aspects of the present disclosure utilize indicia extracted from the photograph taken as well as the geographic coordinate information to determine a number of points or credits to be awarded to the user, points or credits which can be redeemed for goods or services or anything of value.

Additional aspects of the present disclosure will be apparent to those of ordinary skill in the art in view of the detailed description of various aspects, which is made with reference to the drawings, a brief description of which is provided below.

### BRIEF DESCRIPTION OF THE DRAWINGS

FIG. 1 is a functional block diagram of a system for implementing one or more aspects of the present disclosure;

FIGS. 2A and 2B illustrate a flow chart diagram implementing a process, method, or procedure according to one or more aspects of the present disclosure; and

FIGS. 3A-3D illustrate screen shots of example graphical user interfaces associated with one or more aspects of the present disclosure.

### DETAILED DESCRIPTION

While the present disclosure can be embodied in many different forms, there is shown in the drawings and will be described various exemplary aspects of the present disclosure with the understanding that the present disclosure is to be considered as an exemplification of the principles thereof and is not intended to limit the broad aspect of the present disclosure to the illustrated aspects.

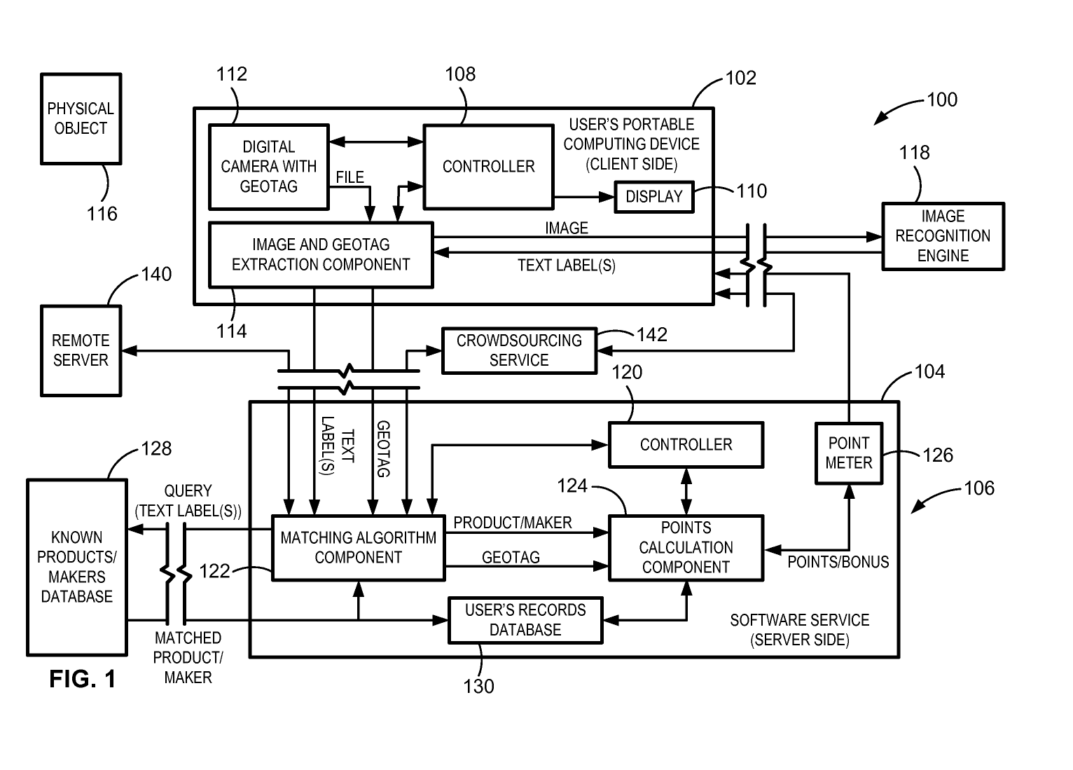

FIG. 1 is a functional block diagram of various components, modules, or features that are involved in some aspects of the present disclosure. A system 100 includes a portable computing device 102, such as a smartphone, laptop, tablet computing device, or the like, carried by a user. The system 100 includes a software service 104 hosted on a server 106 remote from the portable computing device 102. The portable computing device 102 includes a controller 108 operatively coupled to a display 110, a digital imaging device 112, such as a digital camera, and an image and geotag extraction component 114. The digital imaging device 112 is configured to tag digital photographs taken by the digital imaging device 112 with geotags, a form of metadata embedded in the image file produced by the digital imaging device 112, which includes geographic location information including the latitude and longitude coordinates of the location where the digital photograph was taken. The image geotag extraction component 114 extracts the geotag information (generally referred to as location information) from the electronic file produced by the digital imaging device 112 and the image of a physical object 116. The image and geotag extraction component 114 can be a software or functional component of an “app” as they are colloquially referred, or more specifically a mobile software application executed by the controller 108 of the portable computing device 102.

Although only one portable computing device 102 is shown in FIG. 1, it should be understood that many portable computing devices, each like the portable computing device 102, can be communicatively and operatively linked to the software service 104. The software service 104 can support many clients (portable computing devices).

The image and geotag extraction component 114 communicates at least the image of the physical object to an image recognition engine 118, such as the image labeling service available from IQ Engines, Inc. based in Berkeley, Calif. The image file format can be JPEG, TIFF, or any other suitable digital image file format. The geotag metadata can be formatted using the EXIF or XMP formats, for example.

The software service 104 includes a controller 120 that is coupled to a matching algorithm component 122 and to a points calculation component 124. The software service 104 also includes a point meter 126, which keeps track of the number of points accrued by the users of the software service 104 as explained in more detail below. The matching algorithm component 122 is operatively coupled to a database 128, which can be optionally located remote from the server 106 or incorporated in the server 106. The database 128 stores information about the physical objects 116 being photographed by the users of portable computing devices, such as known products and the makers of those products. A product can be a tangible good or a service such as a digital service or a service offered over the Internet. A records database 130 stores records associated with various users of the software service 104 and is accessed by the points calculation component 124 to determine what points to award to each user who successfully checks in with the software service 104. The term “software service” refers to its meaning as that term is understood in the context of software architecture, service-oriented architecture (SOA), and refers to a set of software functionalities. An example of a software service is a web service. The software service 104 has both offline and online components or features. The portable computing device 102 conventionally communicates with the software service 104 over a network such as the Internet via a wired, wireless, or cellular communications connection.

It should be emphasized that the exemplary architecture shown in FIG. 1 is not intended to be limiting. For example, the image recognition engine 118 can be incorporated into the portable computing device 102 or into the software service 104. The software service 104 can reside entirely on the portable computing device 102, and the database 128 can be hosted by the same server 106 that also hosts the software service 104.

The image and geotag extraction component 114, under control of the controller 108, transmits the image taken by the digital imaging device 112 to the image recognition engine 118. The image recognition engine 118 is configured to scan the image for indicia and to convert the indicia to corresponding text labels, which the image recognition engine 118 passes back to the image and geotag extraction component 114.

Next, an exemplary operation of various aspects of the present disclosure will be described. The controller 108 receives an electronic file indicative of a digital photograph of a physical object 116 taken by a user. The electronic file includes an image of the physical object 116 and associated location information indicative of a location where the digital photograph was taken. As described above, the location information can be embedded as GPS coordinate metadata in the electronic file.

The portable user device 102 receives, from the image recognition engine 118, an indication of an indicium identified by the image recognition engine 118 as being associated with the physical object 116. The indication of an indicium can be, for example, one or more alphanumeric text labels corresponding to alphanumeric text or graphics comprising alphanumeric text that appear on the physical object 116. In a specific, non-limiting example, if the physical object 116 is a beer bottle, the indicium can include the name of the beer and the brewery who made the beer. The indication of the indicium can take the form of one or more text labels. In another example, the indicium can be the name of a product, if the physical object 116 is a product, and the corresponding maker of the product. These can be expressed as alphanumeric text labels and returned from the image recognition engine 118 in that form.

The controller 108 or the controller 120 grants the user access to the software service 104 based on at least the digital photograph acquired by the digital imaging device 112 and the location information. Both the digital photograph and the location information represent a minimum set of eligibility criteria required to access the software service 104. When the user is granted access to the software service 114, the matching algorithm component 122, under control of the controller 108, 120, determines whether the identified indicium matches one of a predetermined indicia stored in an electronic database, such as the database 128. For example, if the indicium identified by the image recognition engine 118 is a particular brand of beer, the matching algorithm component 122 passes the brand of beer as a text label to the database 128 as a query, and the database 128 returns whether that particular brand of beer was located in the database 128. If the identified indicium matches one of the predetermined indicia in the electronic database 128, the points calculation component 124, under control of the controller 108, 120, calculates a number of points to be awarded as an award to the user based on at least the matching one of the predetermined indicia and the location information. In other words, the number of points awarded is a function of the identified physical object 116 (regardless of whether an indicium associated with that physical object 116 is found in the database 128) and the location information representing where the photograph of the physical object 116 was taken.

The points calculation component 124, under control of the controller 108, 120, adds the calculated number of points to the point meter 126 associated with the user. The points accumulated in the point meter 126 are redeemable for goods or services. The point meter 126 can be displayed on the display 110 of the portable computing device 102 with a graphic indicating the total number of points accumulated by the user.

The identified indicium (e.g., the name of the product corresponding to the physical object) can be stored in a record associated with the user in the user's records database 130. The user's records database 130 includes records each corresponding to a user of a portable computing device, such as the portable computing device 102. As discussed above, multiple portable computing devices, such as thousands or tens of thousands or greater, can be communicatively coupled to one or more servers like the server 106. Each portable computing device corresponds to a unique user, and the user's records database 130 stores a unique record for each user. The user's records database 130 can be composed of one or more databases. For convenience, it is represented diagrammatically in FIG. 1 as a single block. Each record in the records database 130 includes historical indicia each associated with corresponding physical objects and corresponding location information that the user has previously used to be granted access to the software service 104. The record is embodied on a non-transitory computer-readable tangible medium, such as on a hard-disk or solid-state drive or memory device. For example, if the physical objects 116 correspond to beers, the historical indicia can include the names of beers that the user has taken photographs of to check into (gain access to) the software service 104 as well as the corresponding geotag information associated with each photograph. Note that because the digital imaging device 112 tags each photograph with the geotag information, the user's location where the user actually checks into the software service 104 is not relevant. This allows the user to snap a photo of a beer, change locations (e.g., go back home), but still check into the software service 104 at a later point in time from a different location and the matching algorithm component 122 still receives the geotag information extracted from the photograph. This is unlike other check-in schemes where the location of the user's portable computing device 102 is used to check into a software service. Without limiting the scope of the physical object 116, the physical object 116 can correspond to a consumable item, such as a food or beverage that is consumed in a social setting. For example, beer or wine or spirits are consumed typically in a bar, restaurant, or pub in a social setting. The physical object can correspond to a maker of a consumable item. The indicium associated with the consumable item can correspond to a label indicium associated with a container or package or dispenser containing the consumable item or to a maker indicium bearing the name of the maker of the consumable item. In the case of beer, the beer can be contained within a bottle or a can, for example, and the maker (brewery) of the beer can be affixed as a label to the bottle or can.

However, it should be emphasized that the scope of the present disclosure is not limited to any particular physical object. The physical object can be non-naturally occurring (e.g., beer) or naturally occurring (e.g., flowers or birds). In general, the physical object 116 can correspond to anything that is capable of being photographed by a digital imaging device 112, including extra-terrestrial objects such as stars or planets.

The points calculation component 124 can calculate the number of points to be awarded to the user based on any one or more criteria. For example, points can be awarded based on whether the identified indicium (e.g., corresponding to a name of a beer) is the first time the identified indicium has been matched to one of the predetermined indicia as determined by a search of the record associated with the user in the records database 130. For example, if the user takes a photograph of a new beer that the user has not previously checked into the software service 104, the points calculation component 124 can award a bonus number of points to the user's point meter 126 compared to the number of points that are awarded if the identified indicium is not the first time the identified indicium has been matched to one of the predetermined indicia. For example, if this is the second time that the user has checked in with a particular beer, no bonus points are awarded, at least for this criterion (whether this is the first beer this user has checked into the service 104). A bonus corresponds to a number of points and can vary depending on the criterion used to assess whether a bonus number of points are to be awarded to the user.

Alternately or additionally, the points calculation component 124 can calculate the number of points based on whether the location information associated with the identified indicium is the first time the location information appears with the identified indicium in the record. For example, if this is the first time the user has checked into the service 104 with a photograph of a beer in a particular city/town or country or both, the points calculation component 124 adds a bonus number of points to the point meter 126 compared to the number of points that are awarded if the location information associated with the identified indicium is not the first time the location information appears with the identified indicium in the record. For example, if this is the second time that the user has checked in a particular beer to the service 104 from the same location, no bonus points are awarded for this criterion (whether this is the first beer to be checked in at this location).

In these examples, the identified indicium can correspond to a type of the physical object (e.g., a stout versus a pale ale). Alternately or additionally, the points calculation component 124 can calculate the number of points based on whether the type is the first time the type has been matched to any type corresponding to any of the predetermined indicia. For example, if this is the first time the user has checked in a beer of the stout type, the points calculation component 124 awards a bonus number of points to the point meter 126 compared to the number of points that are awarded if the type does match a type corresponding to any of the predetermined indicia in the record. For example, if this is the third or fifteenth time the user has checked in a beer of the stout type, no bonus points are awarded for this criterion (whether this is the first time a beer of a particular type has been used to check into the service 104).

Alternately or additionally, the points calculation component 124 can calculate the number of points based on a frequency of award accumulation by the user in a predefined window of time such that if the user accumulates a threshold number of awards within the predefined window a bonus number of points is added to the point meter 126. For example, if the player achieves 15 awards within an hour, the points calculation component 124 can award a bonus number of points (e.g., 1000 bonus points) for achieving this milestone.

According to any or some aspects of the present disclosure, if the identified indicium does not match any of the predetermined indicia in the database 128, the software service 104 can communicate the image to a remote server 140, which determines whether a match can be located for the given identified indicium. The software service 104 receives from the remote server 140 an indication as to whether the identified indicium is approved for inclusion in the electronic database 128. The remote server 140 can include a human operator that reviews the image to determine one or more indicia associated with the image (e.g., who made the physical object 116 and a brand name corresponding to the physical object 116). If the remote server 140 returns an indication that the identified indicium corresponds to a valid product and/or maker, the points calculation component 124 can award a bonus number of points to the point meter 126 for being the first user to locate the identified indicium. In the case where the physical objects are beer cans or bottles, this bonus scheme incentivizes users to try to find really rare beers to achieve bonus points. Finding common or popular beers would not result in a high number, if any, of bonus points. The rarer the beer, the more bonus points are awarded. Alternately, the first time a new beer is released, this bonus scheme incentivizes users to try to be the first to check into the service 104 with a photograph of the newly released beer.

Alternately or additionally, the points calculation component 124 can calculate the number of points based on whether the location information associated with the identified indicium satisfies a criterion. For example, the criterion can include whether the location information corresponds to a country that is not the user's country of residence. If the user has checked into the service 104 with a photograph of a physical object taken in a country other than the user's country of residence, the points calculation component 124 can add a bonus number of points to the point meter 126. This bonus scheme incentivizes the user to find unique or non-local locations to photograph physical objects and to check into the service 104 using photographs taken at those remote locations. Typically, users will connect or link to other local users, in the case of beer, which is typically a social event that involves local friends or companions within a fixed geographic area. Users who find beers in bars, pubs, or restaurants in other countries or far away from the user's home are awarded with bonus points.

It should be emphasized that the phrase “checking in” refers to the user gaining access to the software service 104 by taking a geotagged digital photograph of the physical object 116 with the digital imaging device 112. A minimum (but not necessarily exclusive) of two items of information are needed by the software service 104: a digital photograph of a physical object 116 and associated location information of the coordinates where that digital photograph was taken. A third item can correspond to a maker of the physical object 116 (e.g., when the physical object 116 is a consumable item such as beer). The points calculation component 124 can further calculate a number of points to award to the user based on the maker of the consumable item in addition to the consumable item and the location information as stated above.

If the identified indicium does not match any of the predetermined indicia in the electronic database 128, the matching algorithm component 122 can communicate the identified indicium or the image to a crowdsourcing service 142, such as a web-based crowdsourcing service. The crowdsourcing service 142 can try to identify the indicium and label it appropriately by associating one or more text labels with the identified indicium. The software service 104 receives from the crowdsourcing service 142 an indication as to whether the identified indicium was identified. If it was, the software service 104 also receives receiving identification information associated with the identified indicium from the crowdsourcing service. For example, if a user attempts to check in to the software service 104 with an unusual or rare beer and this beer is not located in the database 128, the software service 104 sends the image of the beer to the crowdsourcing service 142 for a determination as to the name of the beer and optionally or additionally the brewery that made it. If the crowdsourcing service 142 determines the identity of the beer, this information is passed back to the software service 104, which can have this identification information added to the database 128.

As stated above, a user can accumulated points or bonus points. In addition, the user can award a prize for accumulating a predetermined number of points in the user's point meter 126. For example, when the user has accumulated 30,000 points and/or bonus points in the point meter 126, the user can be awarded a prize of 5,000 points, bringing the total to 35,000 points. Alternately, the points calculation component 124 can award a prize to the user when the user locates a physical object associated with the same identified indicium in a predetermined number of geographic locations. For example, if the user has checked into the service 104 the same (rare) beer found at five different locations, the player is awarded a prize of, for example, 500 points. These prize points are a separate category for the normal points or bonus points the user is awarded based on other criteria.

The user of the software service 104 can link to one or more other users of the software service 104 and be deemed a follower of such other users. The points calculation component 124 can award a prize when the user accumulates a predetermined number of followers, such as 100. This incentivizes users of the software service 104 to have the most number of followers to achieve a special or enhanced social status or standing among the users of the software service 104.

The matching algorithm component 122 can assign a rarity index to the identified indicium. The rarity index indicates a rareness of the identified indicium relative to the other predetermined indicia such that a high rarity index indicates a relatively rare indicium and a low rarity index indicates a relatively common indicium. In the case of beer, a rare beer is assigned to a high rarity index where as a common beer is assigned to a relatively low rarity index. A greater number of points are awarded to the user the higher the rarity index and the greater the distance of the location information from the user's home location. Thus, while a user can be awarded more points based on the rarity of the physical object 116, the user can be awarded even more points for finding a rare physical object 116 at a location that is far away from the user's home location. This incentivizes users to try to find rare beers outside of the user's local geographic area.

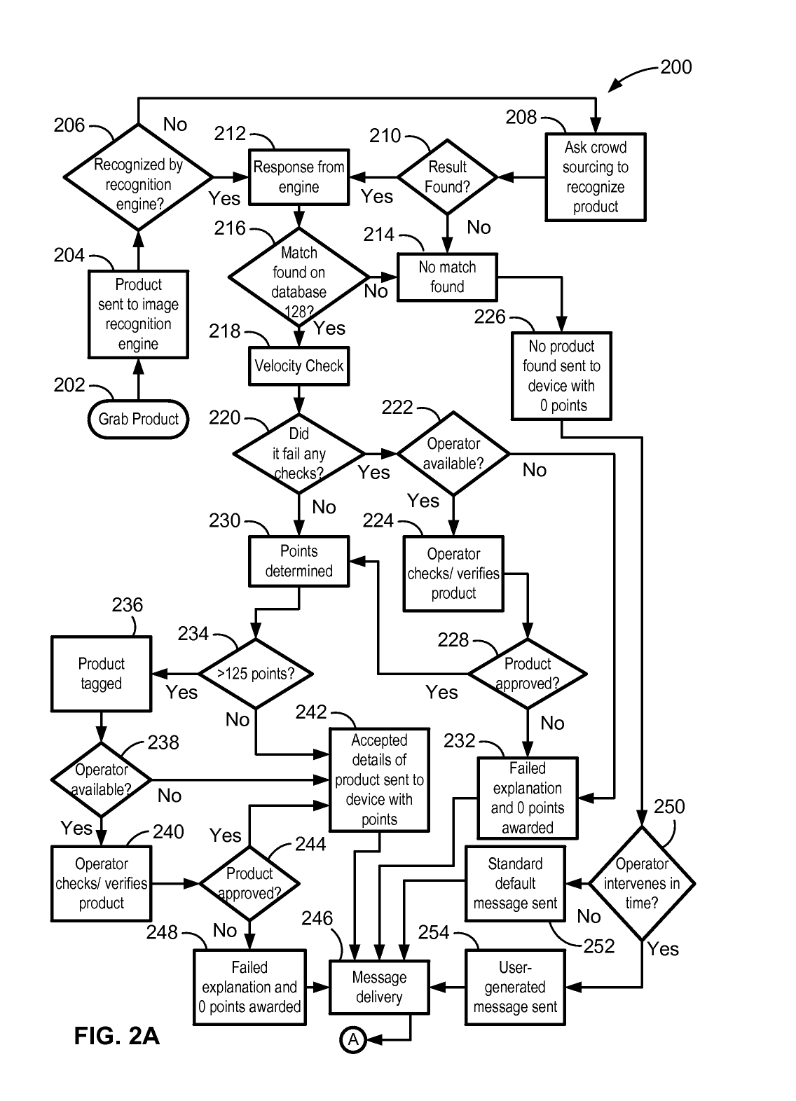

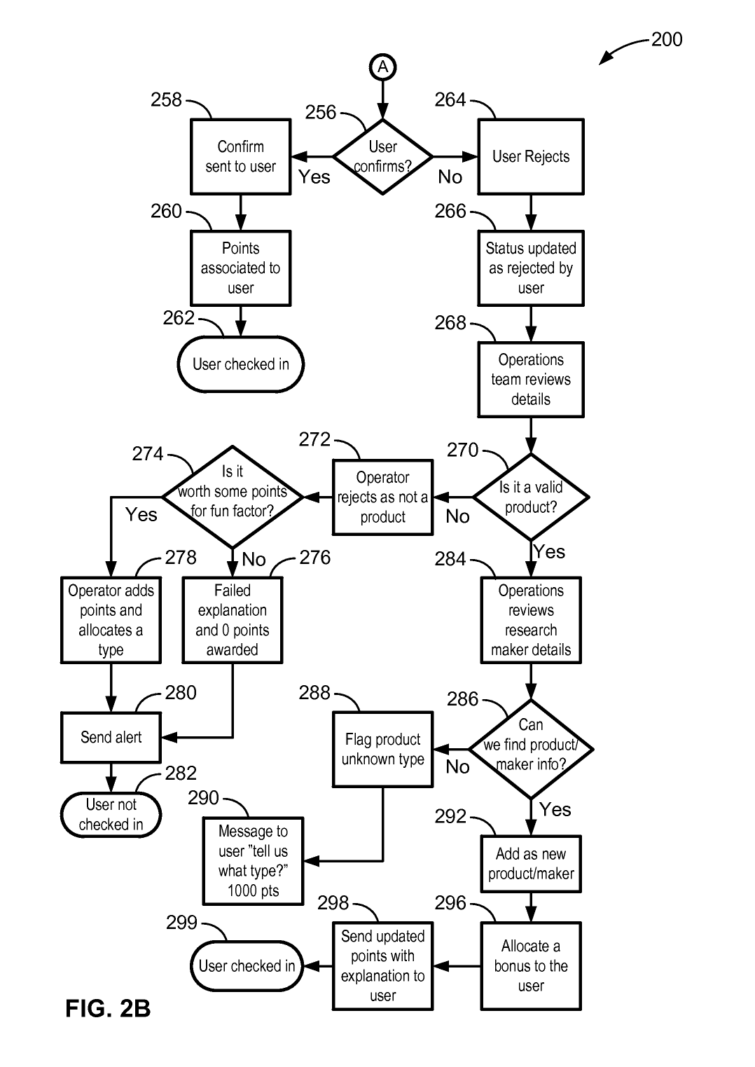

FIGS. 2A and 2B illustrate an example flowchart of an algorithm 200 according to aspects of the present disclosure. For ease of discussion, it will be assumed that the product in question is beer, but as mentioned above, the physical object 116 is not limited to a consumable item. The user grabs a product, such as a beer, by taking a photograph of the beer with the digital imaging device 112 (202). The portable computing device 102 communicates the photograph of the beer, along with the associated geotag metadata, to the image recognition engine 118 (204). The image recognition engine 118 determines whether it can recognize a characteristic of the beer (e.g., the brand and/or brewery name) (206). If so, the image recognition engine 118 returns an indicium such as in the form of a text label (212). As explained above, the text label can correspond to an attribute or a characteristic or a description of the beer, such as the beer name or the brewery that made the beer.

If the image recognition engine 118 does not recognize the beer, the portable computing device 102 or the software service 104 sends the photograph to a crowdsourcing service 142 to determine whether the service 142 can recognize the beer (208). The crowdsourcing service 142 determines whether it can recognize an attribute or characteristic or description of the beer and/or the brewery that made it (210). If the crowdsourcing service 142 can identify the beer, it returns an indicium, such as in the form of text label(s) corresponding to the identified attribute, characteristic, or description of the beer or its maker (212). If the crowdsourcing service 142 cannot determine the beer (214), the portable computing device 102 is informed that no beer could be determined from the photograph and the user is awarded no points (226). Optionally, an operator monitoring the photographs submitted to the crowdsourcing service 142 via the remote server 140 can intervene, and if the operator intervenes in time (250), a message is generated (254) and sent to the portable computing device 102 (246). The operator can send a customized message to the user informing the user that the beer was not recognized and encourage the user to retake the photograph or try again (246). If the operator does not intervene in time (250), a standard default message is generated (252) and sent to the portable computing device (246).

Returning to block 212, if a valid identification information about the photographed beer is determined either by the image recognition engine 118 or by the crowdsourcing service 142 (212), the matching algorithm component 122 determines whether a match can be found for the identified indicium in the database 128 (216). If no match is found (214), the user is awarded no points (226) and an operator can optionally intervene (250) to send a customized message to the user (254) or a standard default message can be generated (252) and sent to the portable computing device 102 (246).

If a match is found in the database 128, the points calculation component 124 optionally carries out a velocity check (218), which is representative of the rate of matches found in a predetermined period of time. If the user is grabbing too many beers at too high a rate, such as more than five per hour, the points calculation component 124 can begin deducting points from the point meter 126 to discourage excessive consumption of beer or to discourage users from trying to “game” the app, such as by taking multiple photographs of beers at a liquor store. If the rate of beer grabs does not exceed a threshold rate (e.g., five per hour), the algorithm 200 determines whether the beer in question fails any checks (220). For example, one check can be whether the location information associated with the geotagged photograph corresponds to any of a predetermined database of liquor stores. If so, the beer can be rejected. Another check can be whether the beer brand matches a brewery. A mismatch between the beer brand and brewery will cause the check to fail, and if an operator is available (222), the operator can check and verify the product (224). If the product is approved (228), the points calculation component 124 determines how many points to award to the user (230). If the beer passes all checks, the points calculation component 124 determines how many points to award to the user (230) as a function of at least the identified indicium and the location information associated with the beer.

Optionally, if the number of points to be awarded exceeds a threshold, such as 125 points (234), the product is tagged (236) and the operator, if available (238), has an opportunity to check and verify the product 240. This check ensures that before a significant number of points (including bonus points or prize points) are awarded to the user, the operator has an opportunity to check or verify the details of the beer and the points before awarding the points to the user. If the operator approves the product (244), the software service 104 accepts the details of the product, and the software service 104 sends to the portable computing device 102 (246) a message indicating that the product has been approved and the number of points to be added to the user's point meter 126 (242). If the operator does not approve the product (244), the user is not awarded any points, and the software service 104 sends a message to the portable computing device 102 indicating an explanation for the failure (248), which the portable computing device 102 can display to the user on the display 110.

If the number of points to be awarded does not exceed the threshold, or if the operator is not available, or if the operator is available and approves the product details, the software service 104 accepts the details of the product, sends a message to the portable computing device 102 that the product has been accepted along with the number of points to be added to the user's point meter 126 (242).

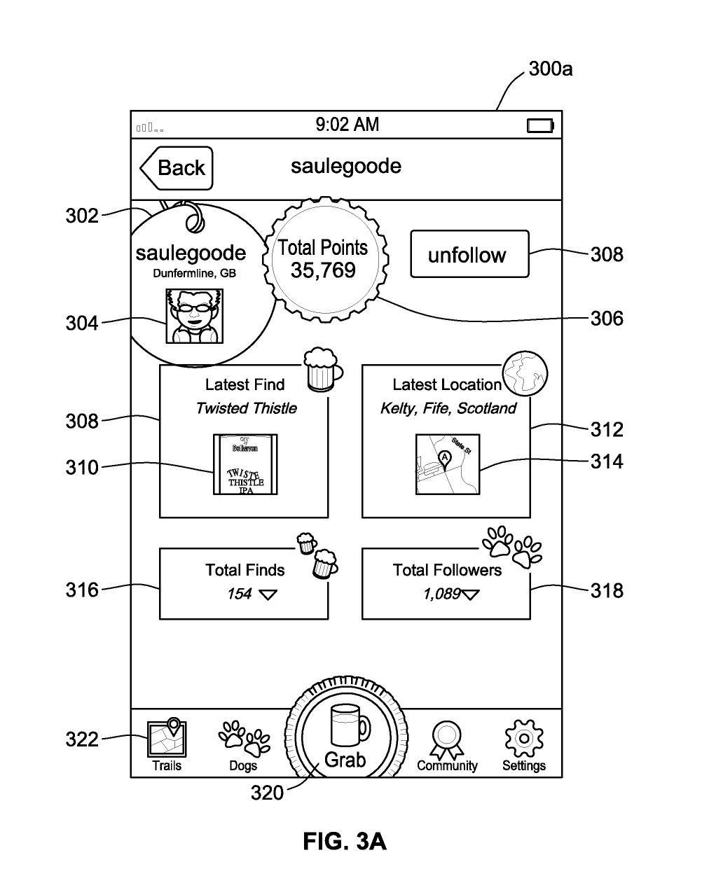

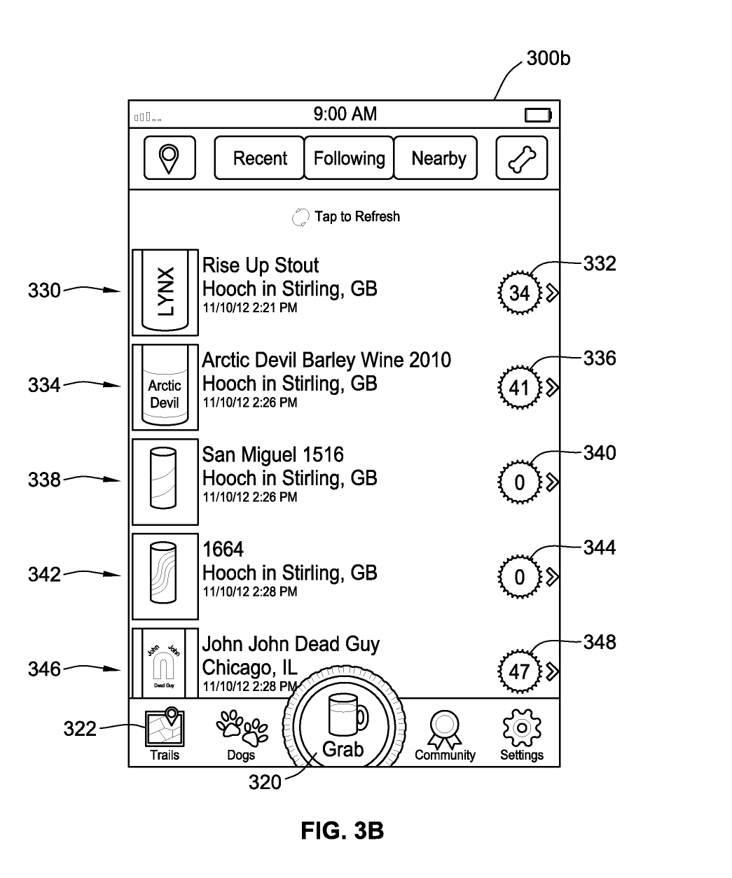

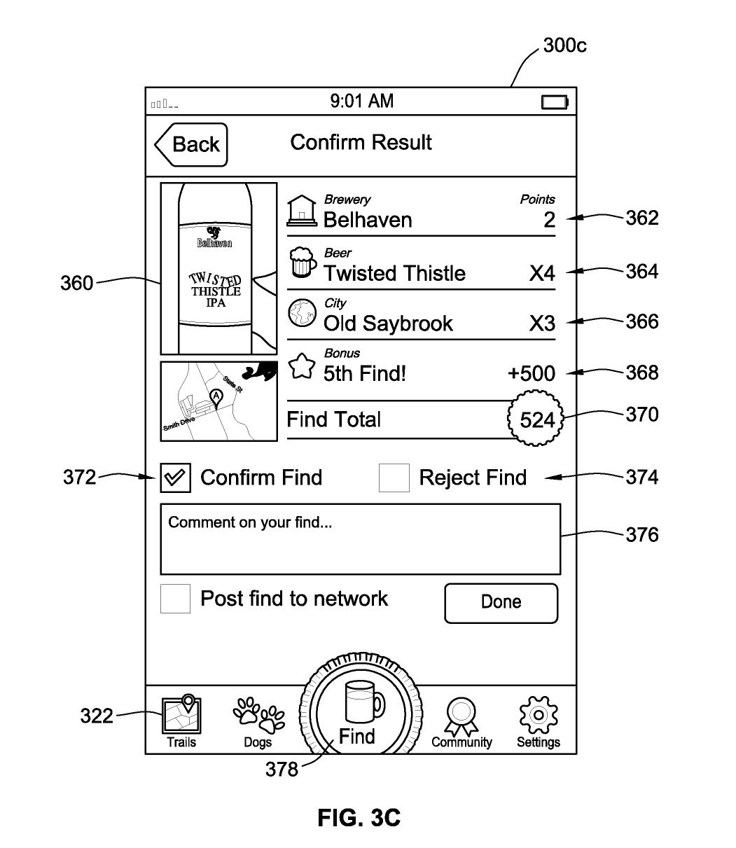

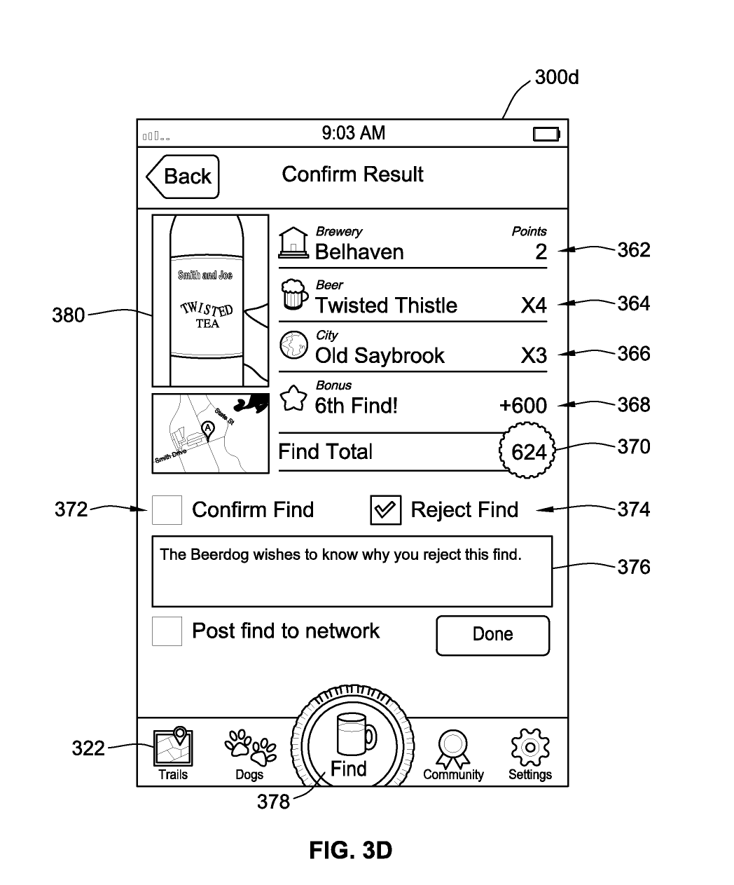

Referring now to FIG. 2B, which is a continuation of the flowchart shown in FIG. 2A, the software service 104 offers the user an opportunity to confirm the product details (256) before accepting the points. This optional feature is described in more detail in connection with FIGS. 3C and 3D. If the user confirms the product (256), meaning that the identified indicium matches the user's understanding of the same, a confirmation message is sent to the user (258), the points to be awarded are added to the user's point meter 126 (260), and the user is checked into the software service 104 (262), which provides the user access to other features of the software service 104, such as social networking features, user comment features, user account or settings/preferences services, point redemption services, for example.

If the user rejects the find (264), a “checked-in” status of the user is updated to reflect that the user has rejected the find (e.g., the identified indicium as corresponding to the photographed object) (266). An operations team, using the remote server 140, reviews the details of the rejected find (268) and determines whether the found product is valid (270). If not, the operator rejects the find as not being a product (272), and then determines whether to award the user points anyway, such as for the “fun factor” of the find (274). If not, no points are awarded to the user along with an explanation as to why (276). If the operator determines that “fun factor” points are to be awarded (274), the operator adds a number of points and allocates a type or category for the award (278). An alert is sent to the user (280) informing the user how many points, if any, were added, and explanatory comments for the award or non-award. The user is not checked in (282) to the service 104, but can still accrue points if the product photographed is determined to be worth awarding “fun factor” points to the user.

Returning to block 270, if the product is determined by the operations team to be a valid product, the operations team reviews research and details about the maker (brewer) of the beer in question (284). If the operations team can find information about the product or maker (286), the operations team adds the product as a new product or maker to the database 128 (292), allocates a bonus award to the user (296) for making a unique and rare find, adds the bonus points to the point meter 126 and sends a message to the user with an explanation for the bonus award (298), and then the software service 104 checks in the user (299) to permit the user access to the software service 104.

However, if the operations team is unable to find information about the beer or its brewer (286), the product is flagged as an unknown type (288), and a message can be sent to the user to have the user tell the operations team what type of beer he or she has found (290) along with an incentive number of points (in this example, 1000 points) if the user complies.

FIG. 3A is an exemplary screenshot of a graphical user interface 300a that can be displayed on the display 110 of the portable computing device 102. The display 110 can be overlaid conventionally by a transparent touchscreen to permit gesture inputs to be made by the (human) user relative to the touchscreen over the surface of the display 110. Various graphical images, some of which are selectable via the touchscreen, are displayed on the graphical user interface 300a. User identification information 302 is displayed along with an avatar 304 selected by the user. The user identification information 302 can include a user name (saulegoode) and the user's geographic location. The point meter 126 can be displayed as a point meter graphic 306 that displays the total number of points accumulated by the user (in this example, 35,769 points). A selectable icon labeled “unfollow” 308 is displayed to allow the user to de-link one or more users so that they can no longer follow or track the user's activities on the software service 104. A “Latest Find” graphic 308 indicates the most recent find by the user, along with an image icon 310 of the found product, which can also include the maker of the product. Next to the “Latest Find” graphic 308 is a “Latest Location” graphic 312 that shows the location where the product on the left was found, along with a map 314 showing the map coordinates of the found product. A total finds meter 316 shows a running tally of the total number of products found by the user. In this example, this user has found 154 beers. A total followers meter 318 shows a running tally of the total number of other users following this user, and in this example, this user has 1,089 followers. A selectable “Trails” icon 322 when selected shows a map with pins for each location where a find was made and checked into the service 104, allowing the user to track all around the world where beers have been found and checked in. A selectable “Grab” icon 320 is pressed by the user to begin a photo grab of a new physical object. When this icon 320 is selected, the digital imaging device 112 is activated to take a photograph of the next physical object 116 the users wishes to check into the service 104.

FIG. 3B is an exemplary screenshot of another graphical user interface 300b that can be displayed on the display 110 of the portable computing device 102. This interface 300b lists a history of finds by the user along with the number of points awarded for each find. The row 330 shows a graphical image of the product photographed, the details of the identified indicium and optionally the brewer of the product and the location where the product was found along with the date and time information as to when the photograph was taken. The award icon 332 indicates that the user was awarded 34 points for this particular find. Similarly, rows 334, 338, 342, 346 show graphical images of the various products photographed, the details of the identified indicium, the brewer if identified, the location, and the date and time when the photograph was taken. The award icons 336, 340, 344, 348 correspond to the number of points awarded for each find, except that in the case of rows 338 and 342, no points were awarded because the products were not matched in the database or no valid product or maker of the product could be ascertained by the operations team, by the database 128, or by the crowdsourcing service 142, or because the user failed a velocity check by checking in too many beers within a predetermined time period.

FIG. 3C is an exemplary screenshot of yet another graphical user interface 300c that can be displayed on the display 110 of the portable computing device 102. In this example, the user has already taken a photograph of the physical object 116 (in this example, a bottle of beer), and the identified indicium has determined that the beer is made by the brewery Belhaven and the name of the beer is Twisted Thistle. The location where the photograph was taken is a city called Old Saybrook. A graphic 360 of the photographed beer is displayed along with a map below it showing the location where the photograph was taken. The user in this interface 300c is being asked to confirm a find. A breakdown of the total number of points to be awarded for this find is also displayed. For example, 2 points are to be awarded for finding a beer made by the brewery Belhaven. The user is awarded a multiplier of 4× 364 for finding a beer named Twisted Thistle. A further multiplier of 3× 366 is awarded for finding the beer in Old Saybrook. And because this beer is the user's fifth such find, the user is awarded a bonus of 500 points 368 for a total of 524 points (370).

A selectable icon 372 is displayed asking the user to confirm this find, and another selectable icon 374 allows the user to reject this find. A comments field 376 allows the user to enter comments on this particular find, which can be posted to a social networking service or posted on the software service 104 for other linked users to view. A selectable “Find” icon 378 allows the user, having taken a photograph, to instruct the software service 104 to see if a match can be found. This interface 300c assumes the software service 104 has found a match, and the details of the match along with the number of points are displayed on this interface 300c. In this example, the user has selected the “Confirm Find” selectable icon, indicating that the user intends to confirm this find. Once confirmed, 524 points will be added to the user's point meter 126.

In the next graphical user interface 300d shown in FIG. 3D, the user has rejected a find. In this example, the product actually photographed is called Twisted Tea not Twisted Thistle. Because the software service 104 has mistakenly identified this find as a sixth such find of a beer called Twisted Thistle, it is about to award the user 624 points. Because the user has rejected the find, the operations team can send a message to the user's portable computing device 102, which is displayed in the comments field 376, inviting the user to explain why this find was rejected. As explained above, as an incentive to the user, a bonus number of points can be awarded to the user for providing an explanation.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. It will be readily understood that the controller 108, 120 can include such a suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular embodiments and applications of the present disclosure have been illustrated and described, it is to be understood that this disclosure is not limited to the precise construction and compositions disclosed herein and that various modifications, changes, and variations can be apparent from the foregoing descriptions without departing from the scope of the invention as defined in the appended claims.

What is claimed is:

1. A method of accumulating points redeemable for goods or services using a visual check-in feature, the method comprising:
receiving, using a controller, an electronic file indicative of a digital photograph of a physical object taken by a user, the electronic file including an image of the physical object and associated location information indicative of a location where the digital photograph was taken;
receiving, from an image recognition engine, an indication of an indicium identified by the image recognition engine as being associated with the physical object;
granting the user, using the controller or another controller, access to a software service based on at least the digital photograph and the location information, the digital photograph and the location information being required to access the software service;
responsive to granting the user access to the software service, determining, using the controller or another controller, whether the identified indicium matches one of a predetermined plurality of indicia stored in an electronic database;
responsive to the identified indicium matching one of the predetermined indicia in the electronic database, calculating, using the controller or another controller, a number of points to be awarded as an award to the user based on at least the matching one of the predetermined indicia and the location information; and
adding, using the controller or another controller, the calculated number of points to a point meter associated with the user, wherein the points accumulated in the point meter are redeemable for goods or services.

2. The method of claim 1, further comprising storing the identified indicium in a record associated with the user, the record including a plurality of historical indicia each associated with corresponding physical objects and corresponding location information that the user has previously used to be granted access to the software service, the record being embodied on a non-transitory computer-readable tangible medium.

3. The method of claim 2, wherein the calculating is further based on whether the identified indicium is the first time the identified indicium has been matched to one of the predetermined indicia as determined by a search of the record associated with the user, and if so, awarding a bonus number of points to the point meter compared to the number of points that are awarded if the identified indicium is not the first time the identified indicium has been matched to one of the predetermined indicia.

4. The method of claim 2, wherein the calculating is further based on whether the location information associated with the identified indicium is the first time the location information appears with the identified indicium in the record, and if so, adding a bonus number of points to the point meter compared to the number of points that are awarded if the location information associated with the identified indicium is not the first time the location information appears with the identified indicium in the record.

5. The method of claim 2, wherein the identified indicium corresponds to a type of the physical object, wherein the calculating is further based on whether the type is the first time the type has been matched to any type corresponding to any of the predetermined indicia, and if so, awarding a bonus number of points to the point meter compared to the number of points that are awarded if the type does match a type corresponding to any of the predetermined indicia in the record.

6. The method of claim 2, wherein the calculating is further based on a frequency of award accumulation by the user in a predefined window of time such that if the user accumulates a threshold number of awards within the predefined window a bonus number of points is added to the point meter.

7. The method of claim 2, further comprising:
responsive to the identified indicium not matching any of the predetermined indicia in the electronic database, communicating the image to a remote server and receiving from the remote server an indication as to whether the identified indicium is approved for inclusion in the electronic database, and if so, the calculating further including awarding a bonus number of points to the point meter for being the first user to locate the identified indicium.

8. The method of claim 2, wherein the calculating is further based on whether the location information associated with the identified indicium satisfies a criterion, and if so, adding a bonus number of points to the point meter.

9. The method of claim 8, wherein the criterion includes whether the location information corresponds to a country that is not the user's country of residence.

10. The method of claim 1,
responsive to the identified indicium not matching any of the predetermined indicia in the electronic database, communicating the identified indicium or the image to a crowdsourcing service; and
receiving from the crowdsourcing service an indication as to whether the identified indicium was identified, and if so, receiving identification information associated with the identified indicium from the crowdsourcing service.

11. The method of claim 1, wherein the physical object is a consumable item or a maker of the consumable item, and wherein the indicium associated with the consumable item corresponds to a label indicium associated with a container or package or dispenser containing the consumable item or to a maker indicium bearing the name of the maker of the consumable item.

12. The method of claim 11, wherein the consumable item is beer and the maker is a brewery.

13. The method of claim 11, wherein the indicium associated with the physical object corresponds to the consumable item, the method further comprising identifying a second indicium associated with the physical object, the second indicium corresponding to the maker of the consumable item, wherein the calculating is based on the maker of the consumable item, the consumable item, and the location information.

14. The method of claim 1, further comprising awarding a prize to the user in response to the point meter accumulating a predetermined number of points.

15. The method of claim 1, further comprising awarding a prize to the user responsive to the user locating a physical object associated with the same identified indicium in a predetermined number of geographic locations.

16. The method of claim 1, further comprising:
linking a second user of the software service to the user as a follower; and
awarding a prize to the user responsive to the user accumulating a predetermined number of followers.

17. The method of claim 1, further comprising assigning a rarity index to the identified indicium, the rarity index indicating a rareness of the identified indicium relative to the other predetermined indicia such that a high rarity index indicates a relatively rare indicium and a low rarity index indicates a relatively common indicium, wherein a greater number of points are awarded to the user the higher the rarity index and the greater the distance of the location information from the user's home location.

18. One or more non-transitory computer-readable media encoded with instructions for carrying out a method, comprising:
receiving, using a controller, an electronic file indicative of a digital photograph of a physical object taken by a user, the electronic file including an image of the physical object and associated location information indicative of a location where the digital photograph was taken;
receiving an indication of an indicium identified by an image recognition engine as being associated with the physical object;
granting the user, using the controller or another controller, access to a software service based on at least the digital photograph and the location information, the digital photograph and the location information being required to access the software service;
responsive to granting the user access to the software service, determining, using the controller or another controller, whether the identified indicium matches one of a predetermined plurality of indicia stored in an electronic database;
responsive to the identified indicium matching one of the predetermined indicia in the electronic database, calculating, using the controller or another controller, a number of points to be awarded as an award to the user based on at least the matching one of the predetermined indicia and the location information; and
adding, using the controller or another controller, the calculated number of points to a point meter associated with the user, wherein the points accumulated in the point meter are redeemable for goods or services.
